(19) United States
(12) Patent Application Publication
(10) Pub. No.: US 2009/0296639 A1
(43) Pub. Date: Dec. 3, 2009

(54) WIRELESS BASE STATION, CHANNEL ALLOCATING SYSTEM, AND CHANNEL ALLOCATING METHOD

(75) Inventors: Masanori Kato, Yokohama-shi (JP); Shigeru Kimura, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: Kyocera Corporation, Kyoto (JP)

(21) Appl. No.: 12/091,729

(22) PCT Filed: Oct. 26, 2006
(86) PCT No.: PCT/JP2006/321404

§ 371 Date: Jun. 3, 2009

(30) Foreign Application Priority Data
Oct. 28, 2005 (JP) 2005-315195

(51) Int. Cl. H04W 72/04; H04W 72/10; H04B 7/00

(52) U.S. Cl. 370/329; 455/452.1; 455/509

(57) ABSTRACT

A wireless base station for allocating one or more communication channels to each terminal so as to perform wireless communication therewith. The wireless base station includes a communication state acquiring device for acquiring a communication state of each communication channel allocated to each terminal; an interference channel determining device for selecting a communication channel having a worst communication state based on the acquired communication state, and determining one or more communication channels which interfere with the selected communication channel; a terminal selecting device for selecting a terminal having a best communication state from among terminals to which each determined communication channel is allocated; and a communication channel allocating device for allocating a communication channel, which belongs to the determined one or more communication channels and has been allocated to the terminal selected by the terminal selecting device, to a new terminal which newly communicates with the wireless base station.

### TECHNICAL FIELD

The present invention relates to a wireless base station for allocating one or more communication channels to each terminal so as to perform wireless communication, and a relevant channel allocating system and method.

Priority is claimed on Japanese Patent Application No. 2005-315195, filed Oct. 28, 2005, the contents of which are incorporated herein by reference.

### BACKGROUND ART

In a conventional wireless communication system including a wireless base station and terminals which communicate therewith, when the wireless base station allocates a channel to a terminal, a channel having a high priority is selected, and a channel, which has a power ratio (of a desired wave to an interference wave) greater than or equal to a predetermined threshold, is selected. Such a predetermined threshold is set to a different value depending on the priority of each channel. The priority of each channel is determined by each wireless base station. When determining the priority, the power of the interference wave with respect to each channel is measured. When the measured value is smaller than a predetermined value, the priority is increased, and when the measured value is greater than or equal to the predetermined value, the priority is decreased. Therefore, channel allocation is determined based on the power ratio of the desired wave to the interference wave of each channel with respect to each terminal which is connected at present (see, for example, Patent Document 1: Japanese Unexamined Patent Application, First Publication No. H06-191079).

However, the method shown in Patent Document 1 depends on turns in connection, that is, a channel having a small interference is allocated to a terminal which is connected to the wireless base station earlier, and a channel having a large interference is allocated to a terminal which is connected to the wireless base station later. Therefore, each terminal has a different amount of interference in accordance with the tams in channel allocation. In this case, no specific problem occurs in a wireless communication system in which the wireless base station performs allocation of a single carrier frequency. However, in a wireless communication system (relating to the present invention) in which the wireless base station performs allocation of a plurality of carrier frequencies and spatial channels, difference in the amount of interference between the terminals is more distinctive in accordance with the terms in channel allocation. In addition, when the wireless base station allocates a plurality of channels to the terminals, a channel allocated to a terminal having a small amount of interference may be identical to a channel allocated to a terminal which is newly connected. In this case, no problem occurs when the terminal having a small amount of interference and the newly-connected terminal are distant form each other, and thus interference therebetween is small. However, if both terminals move and approach each other, the power ratio of a desired wave to an interference wave may suddenly degrade with respect to all channels. Therefore, when the wireless base station performs allocation of a plurality of carrier frequencies, if the allocation is performed simply based on the reception quality (e.g., SIN (signal to Interference and noise ratio)) of each terminal at each relevant time, then a considerable difference in the amount of interference tends to occur between a terminal having a small amount of interference and a terminal having a large amount of interference. Therefore, a difference in throughput occurs between the terminals, and it is impossible to provide impartiality between the terminals.

### DISCLOSURE OF INVENTION

In light of the above circumstances, an object of the present invention is to provide a wireless base station, and relevant channel allocating system and method, by which the throughput of the entire system as the total throughput of all terminals can be improved while the difference between the throughputs of the terminals can be reduced.

Therefore, the present invention provides a wireless base station for allocating one or more communication channels to each terminal so as to perform wireless communication therewith, the wireless base station comprises:

a communication state acquiring device for acquiring a communication state of each communication channel allocated to each terminal;

an interference channel determining device for selecting a communication channel having a worst communication state based on the communication state acquired by the communication state acquiring device, and determining one or more communication channels which interfere with the selected communication channel;

a terminal selecting device for selecting a terminal having a best communication state from among terminals to which each communication channel, which is determined by the interference channel determining device and interferes with the selected communication channel, is allocated; and

a communication channel allocating device for allocating a communication channel, which belongs to the one or more communication channels determined by the interference channel determining device and has been allocated to the terminal selected by the terminal selecting device, to a new terminal which is going to newly communicate with the wireless base station.

Typically, when there is a communication channel which has not yet been allocated, the communication channel allocating device gives priority to this communication channel to be allocated to the new terminal.

In a preferable example:

the communication channels to be allocated include communication channels obtained by combined channel division which use both a space division multiplexing method and a second division multiplexing method; and

as the communication channel to be allocated by the wireless base station to the new terminal, among the already-allocated communication channels, a communication channel obtained by the combined channel division is given priority in comparison with a communication channel obtained by channel division which uses only the space division multiplexing method.

In this case, typically, said second division multiplexing method is a frequency division multiplexing method.

In a typical example, said communication channel having the worst communication state and said one or more communication channels which interfere with this communication channel are obtained by channel division which uses only a space division multiplexing method.

In another typical example, the communication state acquired by the communication state acquiring device is a throughput of each communication channel allocated to each terminal.

The present invention also provides a channel allocating system including terminals and a wireless base station for allocating one or more communication channels to each of the terminals so as to perform wireless communication therewith, wherein:

the wireless base station comprises:

a communication state acquiring device for acquiring a communication state of each communication channel allocated to each terminal;

an interference channel determining device for selecting a communication channel having a worst communication state based on the communication state acquired by the communication state acquiring device, and determining one or more communication channels which interfere with the selected communication channel;

a terminal selecting device for selecting a terminal having a best communication state from among terminals to which each communication channel, which is determined by the interference channel determining device and interferes with the selected communication channel, is allocated; and

a communication channel allocating device for allocating a communication channel, which belongs to the one or more communication channels determined by the interference channel determining device and has been allocated to the terminal selected by the terminal selecting device, to a new terminal which is going to newly communicate with the wireless base station.

The present invention also provides a channel allocating method used in a wireless base station for allocating one or more communication channels to each terminal so as to perform wireless communication therewith, the method comprising:

an acquisition step of acquiring each already-allocated communication channel;

a determination step of determining whether there is a communication channel which has been divided from said each already-allocated communication channel by a multiplexing method other than a space division multiplexing method, and has not yet been allocated; and

a control step of controlling the channel allocation in accordance with the determination in the determination step.

In a typical example, when it is determined in the determination step that there is a communication channel which has been divided by the multiplexing method other than the space division multiplexing method and has not yet been allocated, then in the control step, said communication channel which has not yet been allocated is given priority in the channel allocation.

In another typical example:

in the determination step, when it is determined that there is no communication channel which has been divided by the multiplexing method other than the space division multiplexing method and has not yet been allocated, then it is further determined whether there is a communication channel which has been divided by the space division multiplexing method and has not yet been allocated; and

when there is a communication channel which has been divided by the space division multiplexing method and has not yet been allocated, then in the control step, said communication channel which has not yet been allocated is given priority in the channel allocation.

In a preferable example:

in the determination step, when it is determined that there is no communication channel which has been divided by the multiplexing method other than the space division multiplexing method and has not yet been allocated, then it is further determined whether there is a communication channel which has been divided by the space division multiplexing method and has not yet been allocated; and

when in the control step, there is no communication channel which has been divided by the space division multiplexing method and has not yet been allocated, then the method further comprises:

a step of acquiring a communication state of each communication channel allocated to each terminal;

a step of selecting a communication channel having a worst communication state based on the acquired communication state, and determining one or more communication channels which interfere with the selected communication channel;

a step of selecting a terminal having a best communication state from among terminals to which each determined communication channel interfering with the selected communication channel is allocated; and

a step of allocating a communication channel, which belongs to the determined one or more communication channels and has been allocated to the selected terminal, to a new terminal which is going to newly communicate with the wireless base station.

Typically, said multiplexing method other than the space division multiplexing method is a frequency division multiplexing method.

In accordance with the present invention, among the communication channels which interfere with the communication channel having the worst communication state, one allocated to the terminal having the best communication state is allocated to the newly-added terminal. Therefore, the relevant interference is released, and the communication state of each terminal, which has a bad communication state, can be considerably improved, thereby improving impartiality while the influence due to the relevant channel reduction is small. Accordingly, it is possible to improve the throughput of the entire system, which is the sum of the throughputs of all terminals.

Also in accordance with the present invention, as the communication channel allocated to a terminal with which the wireless base station newly communicates, among the already-allocated communication channels, a communication channel obtained by means of a division method other than the space division multiplexing method is given priority in comparison with a communication channel obtained only by the space division multiplexing method. Therefore, interference does not tend to occur, thereby improving the throughput of the entire system, which is the sum of the throughputs of all terminals.

### BRIEF DESCRIPTION OF TIM DRAWINGS

FIG. 1 is a block diagram showing the general structure of a channel allocating system in first and second embodiments of the present invention.

FIG. 2 shows a flowchart showing the operation of a channel allocation system in the embodiments.

FIG. 3A is a table showing an allocation state of communication channels in the first embodiment.

FIG. 3B is also a table showing the allocation state of communication channels in the first embodiment.

FIG. 4A is a table showing an allocation state of communication channels in the first embodiment.

FIG. 4B is also a table showing the allocation state of communication channels in the first embodiment.

FIG. 5A is a table showings an allocation state of communication channels in the second embodiment.

FIG. 5B is also a table showing the allocation state of communication channels in the second embodiment.

FIG. 6 is a block diagram showing the structure of a channel allocating system using

FIG. 7 is a block diagram showing the structure of a terminal in a 2-antenna MIMO system.

FIG. 8 is a block diagram showing the structure of a terminal in a 4-antenna MIMO system

FIG. 9 is a block diagram showing the structure of a channel allocating system as a third embodiment.

FIG. 10 is a block diagram showing an example of the structure of each terminal in the third embodiment.

FIG. 11 is a block diagram showing another example of the structure of each terminal in the third embodiment.

### BEST MODE FOR CARRYING OUT THE INVENTION

Below, embodiments in accordance with the present invention will be explained with reference to the drawings.

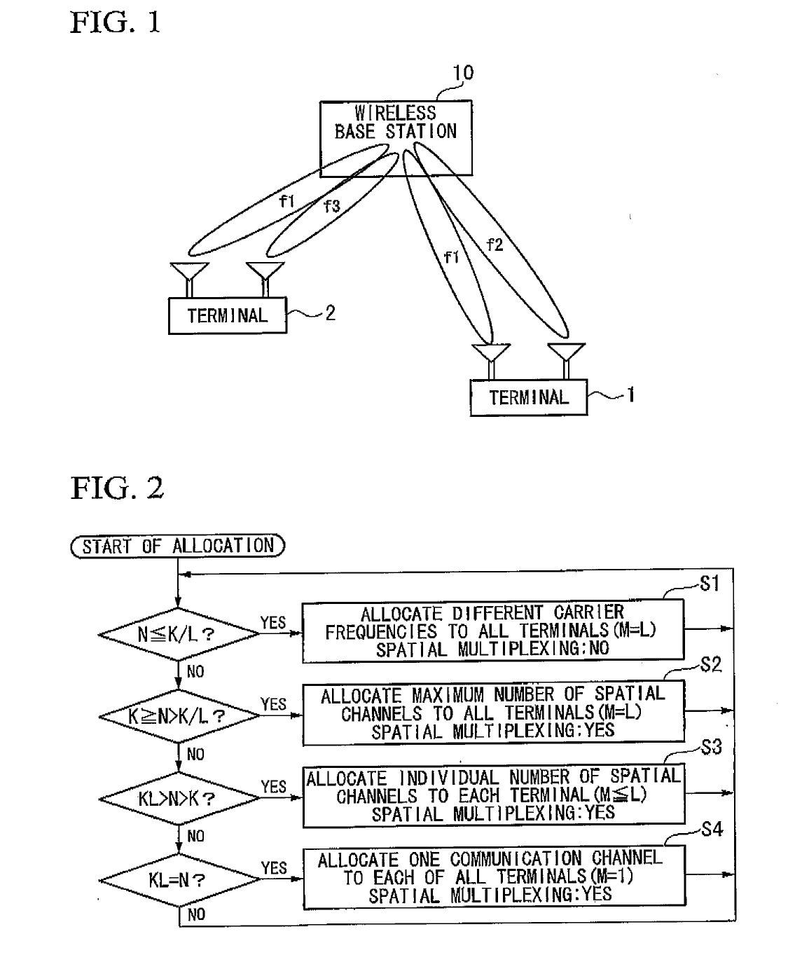

FIG. 1 is a block diagram showing the general structure of a channel allocating system as an embodiment of the present invention. In FIG. 1, reference numeral 10 indicates a wireless base station for receiving signals from terminals by using a plurality of antennas. The wireless base station 10 includes a device for obtaining transmission-path data with respect to each reception, a plurality of antennas, and a transmission device for forming directivity and null (which means a point where the directivity pattern falls) with respect to each of the carrier frequencies based on the transmission-path data, and performing transmission.

By using the above devices, the wireless base station 10 can function as a system using SDMA (spatial division multiple access) which employs a space division multiplexing method for allocating different spatial channels to different terminals by using the same carrier frequency. Simultaneously, the wireless base station 10 can perform transmission to a terminal by using different carrier frequencies by means of a device which can transmit different data items assigned to different carrier frequencies (and different spatial channels). That is, channels obtained by using both the space division multiplexing method and the frequency division multiplexing method can be appropriately allocated to the terminals.

In FIG. 1. terminals 1 and 2 each have (i) a device for performing transmission and reception with respect to each of different carrier frequencies by means of one or more antennas so as to communicate with the wireless base station 10, (ii) a wireless part for performing different and independent transmission and reception processes with respect to the different carrier frequencies, (iii) a baseband part, and (iv) a device for synthesizing each reception data,

In the present channel allocation system, the terminals 1 and 2 each transmit the reception quality (e.g., SINR) to the wireless base station 10. The wireless base station 10 computes an average transmission throughput (ATP) based on an assumed transmission throughput computed by the transmission rate, the number of slots to be allocated, the carrier frequency, and the number of carrier frequencies to be allocated, which are assigned to a modulation class determined in accordance with the reception quality.

In addition, based on the ATP of each communication channel (i.e., SCTP), the wireless base station 10 computes a throughput (fTP) as the sum of the SCTPs at a carrier frequency, a throughput (UTP) as the sum of the SCTPs of a terminal, or the like. Based on each computed throughput, the wireless base station 10 performs the relevant allocation in accordance with the number of terminals to be connected thereto.

As an example of allocation, in FIG. 1, the wireless base station 10 allocates (i) frequencies f1 and f2 to the terminal 1, and (ii) frequencies f1 and f3 to the terminal 2, that is, the same frequency f1 is allocated to the terminals 1 and 2 through different spatial channels by means of spatial multiplexing. Below, a process of providing each combination between the number N of the terminals to be connected to the wireless base station 10, allocated carrier frequencies, and spatial channels via spatial multiplexing will be explained, where the number of carrier frequencies (CFs) is indicated by K, the number of spatial channels (SCs) is indicated by L, the number of communication channels (USCs) is indicated by M, and the number of terminals to be connected is indicated by the above N. Here, the wireless base station 10 basically allocates the maximum number of communication channels (which can be allocated) to the relevant terminals, and the allocation process is continued until the difference in the number of allocated channels between the terminals becomes 1 or smaller.

### FIRST EMBODIMENT

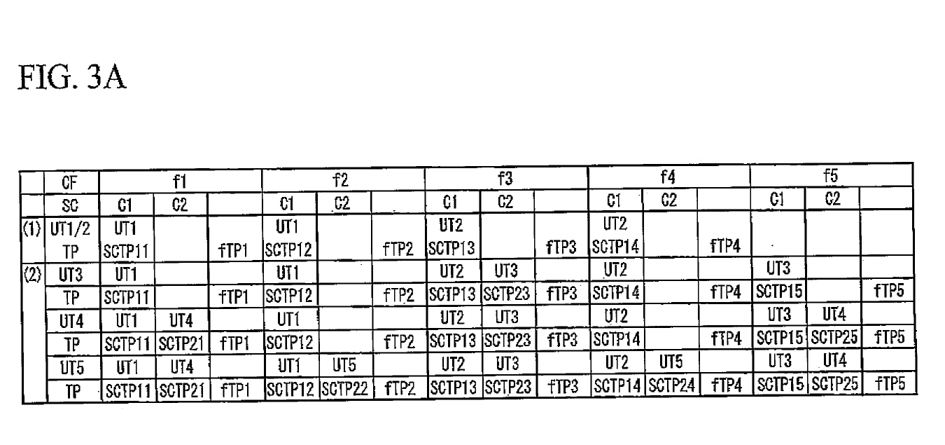

FIG. 2 shows a flowchart of communication-channel allocation, performed by the wireless base station in accordance with the number N of the terminals. The processes in steps S1 to S4 will be explained below.

S1 in case of N≦K/L and M=L (when the number of the terminals is smaller than or equal to the number of the carrier frequencies, and spatial multiplexing is not performed)

As the wireless base station can allocate a different carrier frequency to each terminal to be connected, it allocates an appropriate carrier frequency to each relevant terminal. As the allocation method, the wireless base station may allocate each carrier frequency in a random manner, or in consideration of (i) influence of interference or possibility/impossibility of movement of each terminal, which depends on the position of each terminal (obtained by position data by means of CPS or the like), or (ii) frequencies having diversity effects (for providing an appropriate interval between the allocated frequencies).

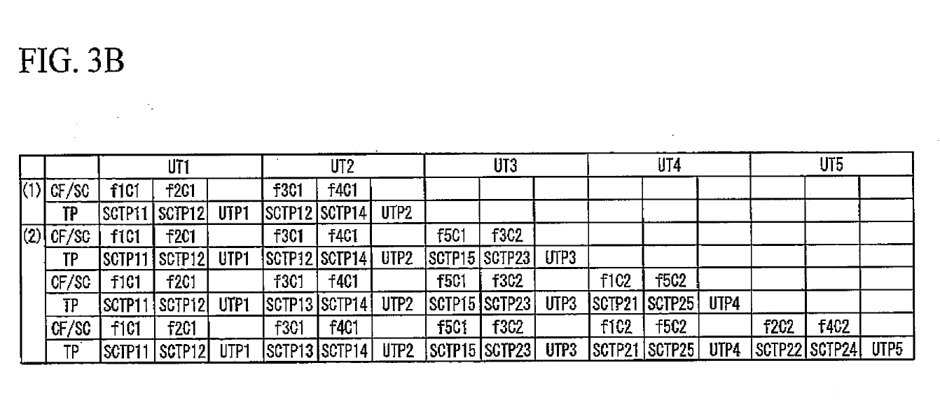

An allocation example in which K=5, L=2, M=2, and N=2 will be shown in part (1) of FIG. 3A (with respect to each frequency) and part (1) of FIG. 3B (with respect to each terminal). In each figure, UT1 to UT5 indicate five terminals (i.e., terminals 1 to 5).

That is, in this example, with respect to two terminals UT1 and UT2 connected to the wireless base station, (i) a communication channel of carrier frequency f1 and spatial channel C1 and a communication channel of carrier frequency f2 and spatial channel C1 are allocated to the terminal UT1, and (ii) a communication channel of carrier frequency f3 and spatial channel C1 and a communication channel of carrier frequency f4 and spatial channel C1 are allocated to the terminal UT2.

S2: in case of K≧N>K/L and M=L (when the number of the terminals is smaller than or equal to the number of the carrier frequencies, and spatial multiplexing is performed)

In step S1, the wireless base station can allocate a different carrier frequency to each terminal to be connected. However, when terminals to be connected to the wireless base station are further added, the wireless base station performs spatial multiplexing for allocating a single carrier frequency to a plurality of terminals, and a spatial channel with respect to the carrier frequency is allocated to each relevant terminal.

Here, it is defined that when the wireless base station allocates a plurality of communication channels to a terminal, the communication channels belongs to different carrier frequencies, that is, no communication channels belonging to the same carrier frequency are not allocated. This is because if the wireless base station allocates a plurality of communication channels, which belong to the same carrier frequency, to a terminal and inference occurs at the carrier frequency, then the communication quality may suddenly degrade. The above definition can prevent such a problem. When the wireless base station allocates a plurality of carrier frequencies to a terminal, even if interference occurs at one of the communication channels, the probability that interference simultaneously occurs at any other terminal is small. Therefore, in this case, the possibility of occurrence of sudden degradation in communication quality is less in comparison with the case in which communication channels of the same frequency are allocated. The following processes a1 to a3 indicate the allocation procedure.

a1: The wireless base station allocates a carrier frequency having a larger number of vacant communication channels preferentially to a target terminal. If there are a plurality of target terminals, a similar allocation method to step S1 is performed.
a2: If a plurality of carrier frequencies have the same number of vacant communication channels, throughputs (UTPS) of the terminals to which the relevant spatial channels are allocated are compared with each other, and in the order of UTP (highest to lowest), the carrier frequencies allocated to each relevant terminal are determined as candidates for allocation to the added terminal.
a3: The wireless base station compares the throughputs (fTPs) of the carrier frequencies as the candidates, and a communication channel belonging to the carrier frequency having the highest fTP is allocated.

An allocation example in which K=5, L=2, M=2, and N=3 to 5 will be shown in part (2) of FIG. 3A (with respect to each frequency) and part (2) of FIG. 3B (with respect to each terminal), and the operation of the allocation process (step S2) in the present embodiment will be explained with reference to the figures.

When another terminal (i.e., terminal 3) is further added to the state in step S1 and it is to be connected to the wireless base station 10, two carrier frequencies are to be allocated to the added terminal. As one of the two frequencies, the wireless base station allocates a vacant carrier frequency f5 (see the above “a1”), and thus all carrier frequencies have been used. Therefore, the next allocation is performed by means of spatial multiplexing. With respect to the candidates, as the wireless base station does not allocate the same carrier frequency, a vacant channel C2 belonging to any one of frequencies f1 to f4 is allocate. Here, the assumed throughputs (UTPs) of the relevant terminals (i.e., UTP1 of terminal 1 and UTP 2 of terminal 2) are compared. If UTP1<UTP2, then in order to reduce influence on the communication quality of the terminal 1 which has a lower UTP, vacant spatial channels of the carrier frequencies f3 and f4 allocated to the terminal 2 are determined as the candidates (sec the above “a2”).

Next, the wireless base station compares the frequency throughputs (fTPs) with respect to the candidates (here, fTP3 of the carrier frequency f3 and fTP4 of the carrier frequency f4). If fTP3>fTP4, then a communication channel of the carrier frequency f3 is determined as the other communication channel allocated to the terminal 3 (see the above “a3”).

When another terminal (i.e., terminal 4) is further added to be connected to the wireless base station 10, if the UTPs of the relevant terminals have a relationship of “UTP1>UTP3 (of the terminal 3)>UTP2”, then similar to the addition of the terminal 3, in the order of UP (highest to lowest), the carrier frequencies allocated to each relevant terminal are determined as candidates for allocation to the added terminal. Here, M=2, then vacant spatial channels of the carrier frequencies allocated to the terminals 1 and 3 are determined as the candidates for allocation to the terminal 4 (see the above “a2”).

First, with respect to the selection of a vacant spatial channel assigned to any carrier frequency allocated to the terminal 1, there are two carrier frequencies f1 and f2. If fTP1>fTP2, then the wireless base station allocates a vacant spatial channel of f1 to the terminal 4. Next, with respect to the selection of a vacant spatial channel assigned to any carrier frequency allocated to the terminal 3, there are two carrier frequencies f3 and f5. However, as there is no vacant spatial channel belonging to f3, the frequency f5 is automatically selected. Therefore, the spatial channels of frequencies f1 and f5 are allocated to the terminal 4 (see the above “a3”).

When another terminal (i.e., terminal 5) is further added to be connected to the wireless base station 10, only one spatial channel is present at each of the carrier frequencies f2 and S4. Therefore, the wireless base station automatically allocates the spatial channels of these carrier frequencies (see the above “a1”).

S3: in case of K·L>N>K and M≦L (when the number of the terminals is smaller than “(the number of carrier frequencies)×(the number of spatial channels)”)

In step S2, the wireless base station performed spatial multiplexing by which all communication channels were allocated, and there is no vacant communication channel to be newly allocated. Therefore, when another terminal is further added, the wireless base station releases a communication channel (selected by a condition explained below) from among the communication channels which have been allocated to the already-connected terminals, and allocates the released communication channel to the newly-connected terminal.

In the present embodiment, different terminals use the same frequency by means of spatial multiplexing. Therefore, the wireless base station selects a communication channel of a terminal whose throughput has been degraded due to interference between the terminals, and allocates the selected communication channel to the newly-connected terminal, so as to reduce the influence of interference, thereby finally improving the throughput of the entire system. In a method for selecting a terminal whose throughput has been degraded due to interference, if the difference between the maximum value (SCTPmax) of SCTPs of the communication channels allocated to the already-connected terminals and SCTP of each communication channel is greater than or equal to a predetermined threshold 1 (TH1) (i.e., “SCTPmax−SCTP##TH1”), then it is determined that the terminal to which the relevant communication channel has been allocated has been influenced by interference.

The following processes b1 to b6 indicate the allocation procedure.

b1: The wireless base station selects a terminal having the lowest UTP among the terminals which satisfy “Mmax−M=0”, where Mmax indicates the maximum value of the number of communication channels allocated to each terminal, and M indicates the number of communication channels allocated to each terminal.
b2. Among the communication channels allocated to the selected terminal, the wireless base station selects each communication channel which satisfies a condition in which the difference between the maximum value (SCTPmax) of the SCTPs of the communication channels allocated to the selected terminal and SCTP of the relevant communication channel is greater than or equal to a predetermined threshold 1 (TH1) (i.e, “SCTPmax−SCTP##≧TH1”).
b3: The wireless base station performs the following processes A to C in accordance with T1N (≠L) which is the number of the communication channels in which the above difference is greater than or equal to the predetermined threshold 1.
A: in case of T1N=1

There is one communication channel which has been degraded due to interference. Therefore, if SCTP of another terminal, to which the carrier frequency of the relevant spatial channel (which has been degraded) is allocated, is smaller than or equal to a threshold 2 (i.e., TH2), then the wireless base station deletes the allocation of the communication channel which satisfies the condition with respect to the threshold 2, and allocates this communication channel to the newly-connected terminal.

B: in case of 1<T1N<0

There are a plurality of communication channels which have been degraded due to interference. Therefore, for each candidate, it is confirmed whether SCTP of another terminal, to which the same carrier frequency is allocated, is smaller than or equal to the threshold 2 (TH2). If the number of communication channels which satisfy the condition with respect to the threshold 2 is 1, the wireless base station deletes the allocation of this communication channel, and allocates it to the newly-connected terminal. If a plurality of communication channels satisfy the condition with respect to the threshold 2, the wireless base station deletes the communication channel of a terminal having the highest UTP among UTPs of the terminals which satisfy the above condition, and allocates the deleted communication channel to the newly-connected terminal.

C: in case of T1N=0

It is supposed that the terminals are under the following conditions, and no spatial channel influenced by interference cannot be specified:

(i) influence on each communication channel is small;
(ii) all communication channels receive similar influence by interference;
(iii) influence on each communication channel is small, and C/N (carrier to noise ratio) characteristic is superior; or
(iv) influence on each communication channel is small, but C/N characteristic is inferior, and degradation in throughput mainly occurs due to influence of C/N.

In this case, the wireless base station cannot specify a communication channel having interference. Therefore, improvement in throughput by reducing the interference (i.e., by releasing a communication channel having interference and allocating it to the newly-connected terminal, as described above) may not be anticipated. Although there are varieties of actual influence as described above, the wireless base station selects each spatial channel which satisfies SCTP≦TH3, where TH3 is a predetermined threshold 3. The number of the selected spatial channels is indicated by T3N.

When T3N=1, then with respect to the carrier frequency of the communication channel which satisfies the relevant condition, if SCTP of the relevant carrier frequency of another terminal, to which the relevant carrier frequency is allocated, is smaller than or equal to the above threshold 2, the wireless base station releases the allocation of the communication channel of this terminal, and allocates the released communication channel to the newly-connected terminal.

If SCTP of the communication channel allocated to the newly-connected terminal has been smaller than or equal to the threshold 3 due to interference, one of the communication channels which have interfered with each other is allocated to the newly-connected terminal. Therefore, the throughput of the other terminal improves, and the throughput of the system (i.e., STP) in consideration of this throughput and the throughput of the newly-connected terminal is further improved. If degradation is caused not by interference but, for example, by degradation in C/N, then the relevant terminal does not satisfy the above condition with respect to the threshold 2 in most cases. Therefore, the probability that the relevant allocation process is applied to a terminal which is influenced by interference is high.

When 1<T3N<L, that is, when a plurality of communication channels satisfy the relevant condition, then for each candidate, it is confirmed whether SCTP of another terminal, to which the same carrier frequency is allocated, is smaller than or equal to the threshold 2 (TH2). If the number of communication channels which satisfy the condition with respect to the threshold 2 is 1, the wireless base station deletes the allocation of this communication channel, and allocates it to the newly-connected terminal. If a plurality of communication channels satisfy the condition with respect to the threshold 2, the wireless base station deletes the communication channel of a terminal having the highest UTP among UTPs of the terminals which satisfy the above condition, and allocates the deleted communication channel to the newly-connected terminal.

b4: If all communication channels cannot satisfy the condition with respect to the threshold 2 through the processes b1 to b3, the wireless base station repeats the process of b1 from the start thereof, with respect to a terminal having the next lowest UTP.
b5: If the conditions with respect to the processes b1 to b4 are not satisfied, then the wireless base station does not consider the condition with respect to the threshold 2 in the processes b1 to b3, and releases a communication channel of a relevant terminal so as to allocate it to the newly-connected terminal.
b6: The number M of communication channels varies in accordance with the allocation processing. In order to provide impartiality, a similar number of channels should be allocated to each channel. Therefore, when the maximum value and minimum value of the number of communication channels allocated to each terminal are respectively indicated by Mmax and Mmin, the wireless base station repeats the allocation processes b1 to b5 until Mnax−Mnin is smaller than or equal to 1.

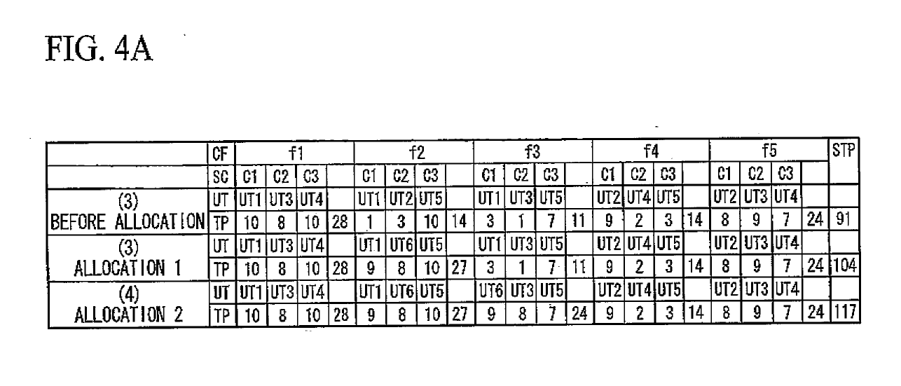

An allocation example in which K=5, L=3, M=3, and N=6 will be shown in FIG. 4A (with respect to each frequency) and FIG. 4B (wit respect to each terminal), and the operation of the allocation process S3 in the present embodiment will be explained with reference to the figures. In each figure, UT1 to UT6 indicate six terminals (i.e., terminal 1 to terminal 6). In addition, each communication channel (USC) of each terminal is indicated by CCx (“x” indicates the channel number).

The terminals 1 to 5 have already been connected to the wireless base station 10, and thus all communication channels have been allocated through the methods of the above steps S1 and S2, as shown in the parts (3) (“before allocation”) in FIGS. 4A and 4B. The spatial-channel allocating operation performed when another terminal 6 is newly added and is connected to the wireless base station 10 so as to perform communication will be explained below.

In order to show the throughputs in an easily-understandable manner, the SCTP of each terminal is indicated by pseudo numerical values from 1 (most lowest) to 10 (most highest). Similarly, the throughput fTP of each carrier frequency and the throughput UTP of each terminal are each indicated by a numerical range from 3 to 30, and the throughput STP of the entire system is also indicated using a numerical value as au image. Such numerical values are shown in the part (3) (“before allocation”) in FIGS. 4A and 4B, and the threshold 1 and the threshold 2 are respectively set to 6 and 3.

Among the terminals 1 to 5 which satisfy “Mmax−M=0”, the terminal 1 has the lowest UTP (i.e., 14) with reference to the part (3) (“before allocation”) in FIG. 4B (see the above “b1”), As the maximum value of the SCTPs of the terminal 1 is 10 of the communication channel CC1 of the carrier frequency f1 (i.e., f1C1), it is confirmed whether the difference between the value (10) and SCTP of each other communication channel is greater than or equal to the threshold 1 (i.e., 6). Here, with respect to the communication channel CC2 (i.e., f2C1), 10−1=9, and with respect to the communication channel CC3 (i.e., f3C1), 10−2=8. Therefore, both cases satisfy the relevant condition. Accordingly, it can be assumed that the carrier frequencies f2 and f3 have large interference (i.e., T1N=2) (see the above “b2”).

Next, when each terminal which interferes with the carrier frequency f2 of the terminal 1 is checked, one or both of the terminals 2 and 5, to which the carrier frequency f2 has been allocated (see FIG. 4A), are candidates.

Here, with respect to the carrier frequency f2 of the terminal 2, SCTP=3, which is smaller than or equal to the threshold 2 (i.e., 3). On the other hand, with respect to the carrier frequency f2 of the terminal 5, SCTP=10, which is larger than the threshold 2 (i.e., 3). Therefore, it can be estimated that the terminal 2 interferes with the terminal 1.

Next, when each terminal which interferes with the carrier frequency f3 of the terminal 1 is similarly checked, the terminals 3 and 5 are determined as candidates. The interference with respect to each of these terminals is then checked similar to the above case of the carrier frequency f2, the terminal 3 is a target terminal.

Through the above processes, the candidates of the communication channel to be allocated by the wireless base station 10 to the terminal 6 is f2C2 (i.e., carrier frequency 2 and spatial channel C2) of the terminal 2 or f3C2 (i.e., carrier frequency f3 and spatial channel C2) of the terminal 3.

Next, when comparing the UTP2 (i.e., 20) of the terminal 2 with the UTP3 (i.e., 18) of the terminal 3, UTP2 is larger. Therefore, the wireless base station releases the allocation of the communication channel f2C2 to the terminal 2, and allocates the communication channel f2C2 to the terminal 6 (see “B” in the above “b3”, and the part (3) (“allocation 1”) in FIGS. 4A and 4B) Here, as f2C2 of the terminal 2, which has caused interference with respect to the terminal 1, is released, it is anticipated that SCTP of f2C1 of the terminal 1 is increased. Therefore, UTP1 of the terminal 1, which has been the most lowest, increases, and UTP2 of the terminal 2 is decreased due to the deletion of the channel of f2C2. However, the possibility that the throughput STP of the entire system increases is high (in FIGS. 4A and 4B, STP is improved from 91 (before allocation) to 96 (which does not include UTP (=8) of the terminal 6)), In addition, if the terminal 6 is not present in an area which causes interference with the terminal 1, then UTP6 of the terminal 6 can be further added, so that STP=104. Here, after the reduction of interference, the value (9) of SCTP of the communication channel CC2 of the terminal 1 and the value (8) of SCTP of the communication channel CC1 of the terminal 6 are assumed values.

In the present state, the maximum value Mmax of the number of spatial channels allocated to each terminal is 3 (with respect to the terminals 1, 3, 4, and 5), and the minimum value Mmin is 1 (with respect to the terminal 6), so that Mmax−Mmin=2. Therefore, the wireless base station 10 further allocates a communication channel to the terminal 6, and performs the allocation process similar to the above. Although the terminal 2 has the lowest UTP at present, the number M of the allocated communication channels is 2, that is, Mmax(3)−M(2)≠0. Therefore, the terminal 2 cannot be a target.

Among the terminals which satisfy the condition “Mmax−Mmin=0”, the terminal 3 has the lowest UTP (i.e., 18) (see the above “b1”). When the wireless base station 10 performs the similar processes as described above, the possibility that the communication channel CC3 (f3C2) of the terminal 3 and the communication channel CC3 (f3C1) of the terminal 1 interfere with each other is high. Therefore, the communication channel CC3 (S3C1) of the terminal 1 is deleted, and this communication channel is allocated to the terminal 6 (see “A” of the above “b3”). Accordingly, UTP3 of the terminal 3 improves, and the system throughput STP also improves (see the part (4) (“allocation 2” in FIGS. 4A and 4B).

Through the above processes, “Mmax(3)−Mmin(2)” becomes 1, and thus the allocation operation is completed.

S4: in case of K·L=N

One communication channel is allocated to each of all terminals connected to the wireless base station (i.e., Mmax=Mmin=1).

### SECOND EMBODIMENT

A second embodiment having the same structure (see FIG. 1) as the first embodiment will be explained as another embodiment for taking preference to impartiality with respect to the throughput between the terminals. The processes in steps S1 to S4 (in FIG. 2) of the present embodiment will be explained below.

Steps S1, S2, and S4 are performed similar to the first embodiment.
S3: in case of K·L>N>K and M≦L (when the number of the terminals is smaller than “(the number of carrier frequencies)×(the number of spatial channels)”)

In step S2, the wireless base station performed spatial multiplexing by which all communication channels were allocated, and there is no vacant communication channel to be newly allocated. Therefore, when another terminal is further added, the wireless base station releases a communication channel (selected by a condition explained below) from among the communication channels which have been allocated to the already-connected terminals, and allocates the released communication channel to the newly-connected terminal.

In the present embodiment, different terminals use the same frequency by means of spatial multiplexing. Therefore, the wireless base station selects a communication channel of a terminal whose throughput has been degraded due to interference between the terminals, and allocates the selected communication channel to the newly-connected terminal, so as to reduce the influence of interference, thereby finally improving the throughput of the entire system. In a method for selecting a terminal whose throughput has been degraded due to interference, if the difference between the maximum value (SCTPmax) of SCTPs of the communication channels allocated (by the wireless base station) to the already-connected terminals and SCTP of each communication channel is greater than or equal to a predetermined threshold 1 (TH1) (i.e., “SCTPmax−SCTP##≧TH1”), then it is determined that the terminal to which the relevant communication channel has been allocated has been influenced by interference.

The following processes c1 to c6 indicate the allocation procedure.

c1: The wireless base station selects a terminal having the lowest UTP among the terminals which satisfy “Mmax−M=0”, where Mmax indicates the maximum value of the number of communication channels allocated (by the wireless base station) to each terminal, and M indicates the number of communication channels allocated to each terminal.
c2: Among the communication channels allocated to the selected terminal, the wireless base station selects each communication channel which satisfies a condition in which the difference between the maximum value (SCTPmax) of the SCTPs of the communication channels allocated to the selected terminal and SCTP of the relevant communication channel is greater than or equal to a predetermined threshold 1 (TH1) (i.e., “SCTPmax−SCTP##≧TH1”).
c3: The wireless base station performs the following processes A to C in accordance with T1N (≠L) which is the number of the communication channels in which the above difference is greater than or equal to the predetermined threshold 1.
A. in case of T1N=1

There is one communication channel which has been degraded due to interference. Therefore, if SCTP of another terminal, to which the carrier frequency of the relevant spatial channel (which has been degraded) is allocated, is smaller than or equal to a threshold 2 (i.e., TH2), then the wireless base station deletes the allocation of the communication channel which satisfies the condition with respect to the threshold 2, and allocates this communication channel to the newly-connected terminal.

B: in case of 1<T1N<0

There are a plurality of communication channels which have been degraded due to interference. Therefore, for each candidate, the wireless base station confirms whether SCTP of another terminal, to which the same carrier frequency is allocated, is smaller than or equal to the threshold 2 (TH2). If the number of communication channels which satisfy the condition with respect to the threshold 2 is 1, the wireless base station deletes the allocation of this communication channel, and allocates it to the newly-connected terminal.

If a plurality of communication channels satisfy the condition with respect to the threshold 2, the wireless base station compares the throughputs SCTPs of the communication channels (which satisfy the relevant condition) of the terminal with each other, and deletes the communication channel having the lowest SCTP so as to allocate the deleted communication channel to the newly-connected terminal.

C: in case of T1N=0

It is supposed that the terminals are under the following conditions, and no spatial channel influenced by interference cannot be specified:

(i) influence on each communication channel is small;
(ii) all communication channels receives similar influence by interference;
(iii) influence on each communication channel is small, and C/N characteristic is superior; or
(iv) influence on each communication channel is small, but C/N characteristic is inferior, and degradation in throughput mainly occurs due to influence of C/N.

In this case, the wireless base station cannot specify a communication channel having interference. Therefore, improvement in throughput by reducing the interference (i.e., by releasing a communication channel having interference and allocating it to the newly-connected terminal, as described above) may not be anticipated. Although there are varieties of actual influence as described above, the wireless base station selects each spatial channel which satisfies SCTP≦TH3, where TH3 is a predetermined threshold 3. The number of the selected spatial channels is indicated by T3N.

When T3N=1, then with respect to the carrier frequency of the communication channel which satisfies the relevant condition, if SCTP of the relevant carrier frequency of another terminal, to which the relevant carrier frequency is allocated, is smaller than or equal to the above threshold 2, the wireless base station releases the allocation of the communication channel of this terminal, and allocates the released communication channel to the newly-connected terminal.

If SCTP of the communication channel allocated to the newly-connected terminal has been smaller than or equal to the threshold 3 due to interference, one of the communication channels which have interfered with each other is allocated to the newly-connected terminal. Therefore, the throughput of the other terminal improves, and the throughput of the system (i.e., STP) in consideration of this throughput and the throughput of the newly-connected terminal is further improved. If degradation is caused not by interference but, for example, by degradation in C/N, then the relevant terminal does not satisfy the above condition with respect to the threshold 2 in most cases. Therefore, the probability that the relevant allocation process is applied to a terminal which is influenced by interference is high.

When 1<T3N<L, that is, when a plurality of communication channels satisfy the relevant condition, then for each candidate, the wireless base station confirms whether SCTP of another terminal, to which the same carrier frequency is allocated, is smaller than or equal to the threshold 2 (TH2). If the number of communication channels which satisfy the condition with respect to the threshold 2 is 1, the wireless base station deletes the allocation of this communication channel, and allocates it to the newly-connected terminal. If a plurality of communication channels satisfy the condition with respect to the threshold 2, the wireless base station compares the throughputs SCTPs of the communication channels (which satisfy the relevant condition) of the terminal with each other, and deletes the communication channel having the lowest SCTP so as to allocate the deleted communication channel to the newly-connected terminal.

c4: If all communication channels cannot satisfy the condition with respect to the threshold 2 through the processes c1 to c3, the wireless base station repeats the process of c1 from the start thereof, with respect to a terminal having the next lowest UTP.
c5: If the conditions with respect to the processes c1 to c4 are not satisfied, then the wireless base station does not consider the condition with respect to the threshold 2 in the processes c1 to c3, and releases a communication channel of a relevant terminal so as to allocate it to the newly-connected terminal.
c6: The number M of communication channels varies in accordance with the allocation processing. In order to provide impartiality, a similar number of channels should be allocated to each channel. Therefore, win the maximum value and minimum value of the number of communication channels allocated to each terminal are respectively indicated by Mmax and Mmin, the wireless base station repeats the allocation processes c1 to c5 until Mnax−Mmin is smaller than or equal to 1.

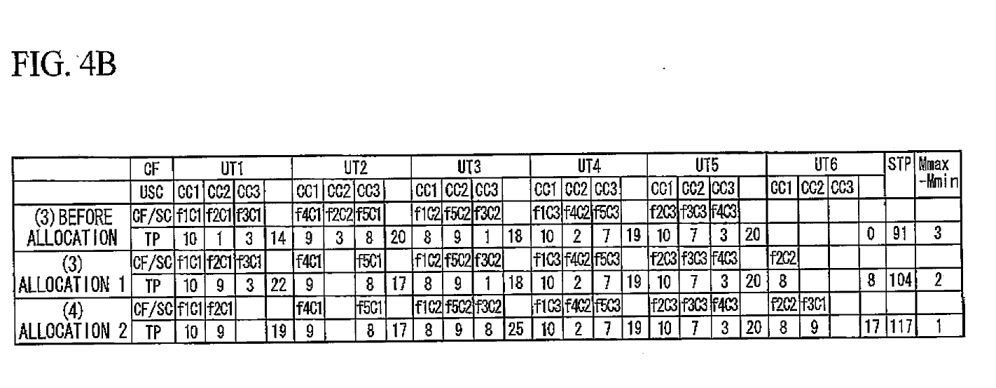

An allocation example in which K=5, L=3, M=3, and N=6 will be shown in FIG. 5A (with respect to each frequency) and FIG. 5B (with respect to each terminal, and the operation of the allocation process S3 in the present embodiment will be explained with reference to the figures. In each figure, UT1 to UT6 indicate six terminals (i.e., terminal 1 to terminal 6). In addition, each communication channel USC) of each terminal is indicated by CCx (“x” indicates the channel number).

Similar to the conditions of the first embodiment, the terminals 1 to 5 have already been connected to the wireless base station 10, and thus all communication channels have been allocated through the methods of the above steps S1 and S2, as shown in the parts (3) (“before allocation”) in FIGS. 5A and 5E. The spatial-channel allocating operation performed when another terminal 6 is newly added and is connected to the wireless base station 10 so as to perform communication will be explained below.

Among UTP1 to TTP5 of the terminals 1 to 5 which satisfy “Mmax−M=0”, the terminal 1 has the lowest UTP (see the above “c1”). As the maximum value of the SCTPs of the terminal 1 is 10 of the communication channel CC1 of the carrier frequency f1 (i.e., f1C1), it is confirmed whether the difference between the value (10) and SCTP of each other communication channel is greater than or equal to the threshold 1. Here, with respect to the communication channel CC2 (i.e., f2C1), 10−1=9, and with respect to the communication channel CC3 (i.e., f3C1), 10−2=8. Therefore, both cases satisfy the relevant condition. Accordingly, it can be assumed that the carrier frequencies f2 and f3 have large interference (i.e., T1N=2) (see the above “c2”).

Next, when each terminal which interferes with the carrier frequency f2 of the terminal 1 is checked, one or both of the terminals 2 and 5, to which the carrier frequency f2 has been allocated (see FIG. 5A), are candidates.

Here, with respect to the carrier frequency f2 of the terminal 2, SCTP=3, which is smaller than or equal to the threshold 2 (i.e., 3). On the other hand, with respect to the carrier frequency f2 of the terminal 5, SCTP=10, which is larger than the threshold 2 (i.e., 3). Therefore, it can be estimated that the terminal 2 interferes with the terminal 1.

Next, when each terminal which interferes with the carrier frequency f3 of the terminal 1 is similarly checked, the terminal 3 is determined as a target terminal.

Through the above processes, the candidates of the communication channel to be allocated to the terminal 6 is CC2 (i.e., f2C2) of the terminal 2 or CC3 (i.e., f3C2) of the terminal 3.

Next, when comparing SCTP (i.e., 3) of CC2 (f2C2) of the terminal 2 with SCTP (i.e., 1) of CC3 (f3C2) of the terminal 3, SCTP of the terminal 3 is lower. Therefore, the wireless base station releases the allocation of the communication channel CC3 (f3C2) of the terminal 3, and allocates the communication channel SC2 to the terminal 6 (see “B” in the above “c3”).

Here, as f3C2 of the terminal 3, which has caused interference with respect to the terminal 1, is released, it is anticipated that SCTP of f3C1 of the terminal 1 is increased, Therefore, UTP1 of the terminal 1, which has been the most lowest, increases, and UTP3 of the terminal 3 is decreased due to the deletion of the channel of f3C2. However, the possibility that the throughput STP of the entire system increases is high (in FIGS. 5A and 5B, STP is improved from 91 (before allocation) to 96 (which does not include UTP (=8) of the terminal 6)). In addition, if the terminal 6 is not present in an area which causes interference with the terminal 1, then UTP6 can be further added, so that STP=104. Here, after the reduction of interference, the value (9) of SCTP of the communication channel CC3 of the terminal 1 and the value (8) of SCTP of the communication channel CC1 of the terminal 6 are assumed values.

In the present state, the maximum value Mmax of the number of spatial channels allocated to each terminal is 3 (with respect to the terminals 1, 2, 4, and 5), an the minimum value Mmin is 1 (with respect to the terminal 6), so that Mmax−Mmin=2. Therefore, the wireless base station 10 further allocates a communication channel to the terminal 6. Among the terminals which satisfy the condition “Mmax−Mmin=2”, the terminal 4 has the lowest UTP (see the above “c1”). When performing the similar processes as described above, the possibility that the communication channel CC2 (f4C2) of the terminal 4 and the communication channel CC3 (f4C3) of the terminal 5 interfere with each other is high. Therefore, the wireless base station deletes the communication channel CC3 (f4C3) of the terminal 5, and allocates this communication channel to the terminal 6 (see “A” of the above “c3”). Accordingly, UTP4 of the terminal 4 improves, and the system throughput STP also improves. Through the above processes, “Mmax(3)−Mmin(2)” becomes 1, and thus the allocation operation is completed.

### THIRD EMBODIMENT

A third embodiment will be explained, which can also be applied to communication between the wireless base station and the terminals as shown in the first and second embodiments.

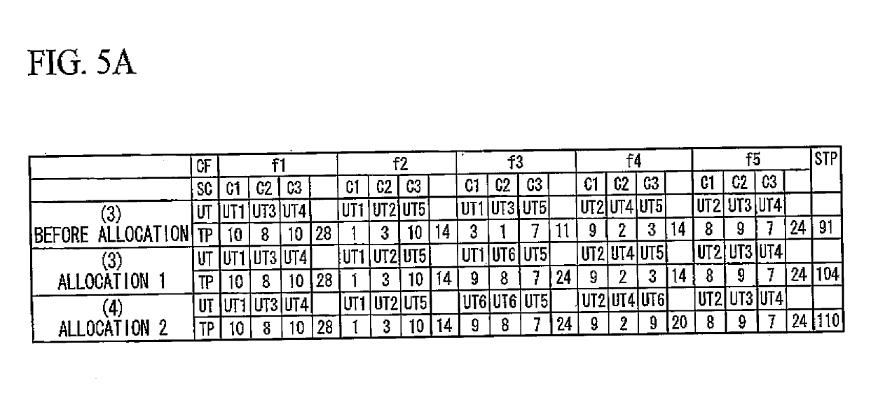

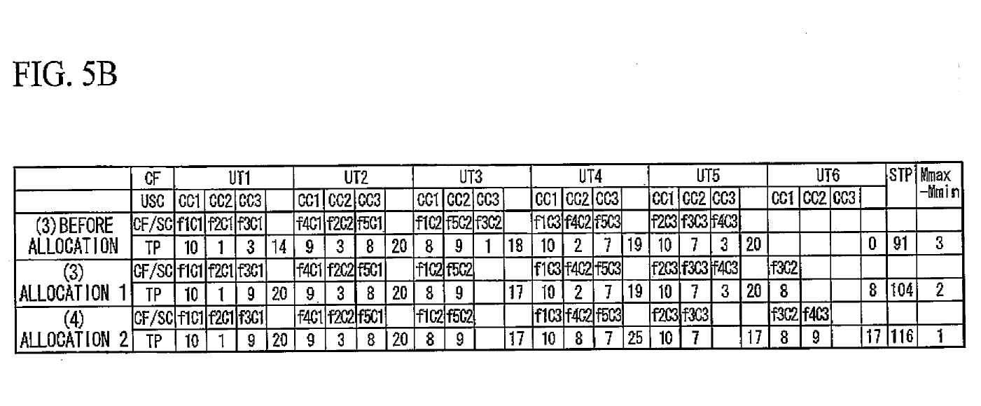

As a system for implementing high-speed wireless communication, MIMO (multiple input multiple output) having a structure shown in FIG. 6 is known. In MEMO, not only a Wireless base station 60 but also terminals 61 to 63 each have a plurality of antennas and a wireless communication function, so that a plurality of channels can be assigned to a single frequency. However, in order to assign a plurality of channels to a single frequency, each terminal (see FIG. 7) should have two antennas 70 and 71 and two wireless communication parts 72 and 73 in addition to a single local transmitter 74, Reference numeral 39 indicates a BB (baseband) part for converting each received signal to a baseband signal.

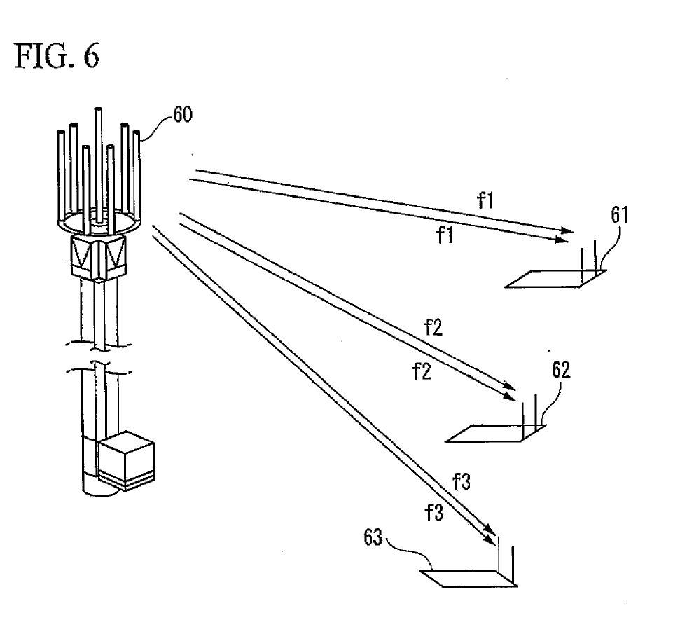

If farther higher communication is required and four channels are assigned to a single frequency, each terminal (see FIG. 8) should have four antennas 80 to 83 and four wireless communication parts 84 to 87, which increases the price of the terminal.

In addition, performance should be degraded if correlation between antennas is suppressed to a low level. However, in a wide-area communication having a cell radius of 1 Km or the like, a rate for suppressing such correlation to a lower level is low.

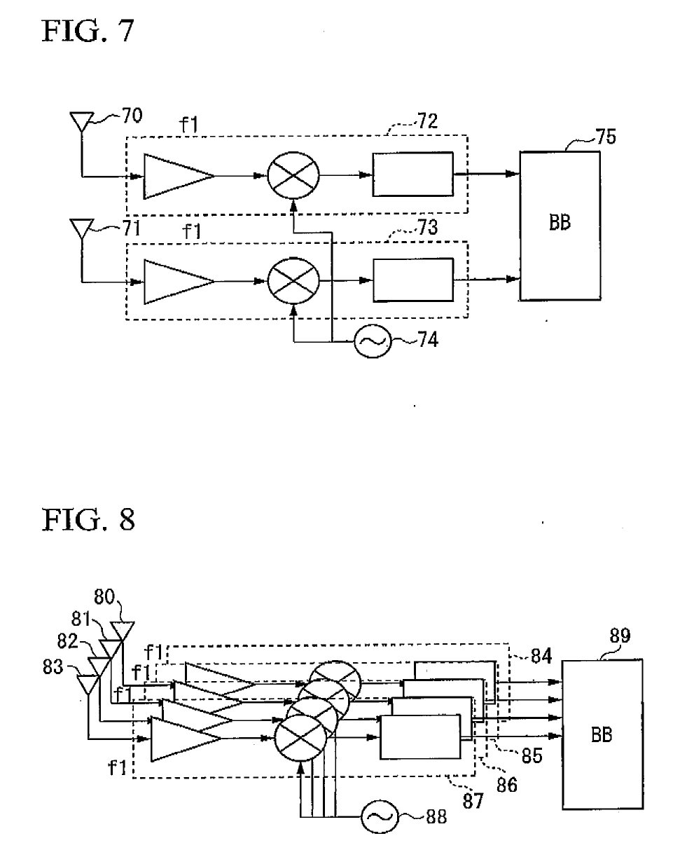

In order to solve the above problem, in the present embodiment (see FIG. 9), between a wireless base station 90 and each of terminals 91 to 93, the wireless base station 90 performs communication in a manner such that although a single frequency is allocated to different terminals by means of SDMA, a plurality of communication channels to which different frequencies are assigned are allocated to each terminal by means of FDMA (frequency division multiple access).

For example, in FIG. 9, frequency f1 is assigned to communication between the Wireless base station 90 and each of the terminals 91 and 93 by means of SDMA, and frequencies f1 and f3 are assigned to communication between the wireless base station 90 and the terminal 91 by means of FDMA. Accordingly, between the wireless base station 90 and the terminal 91, communication can be performed with a data rate in consideration of two channels.

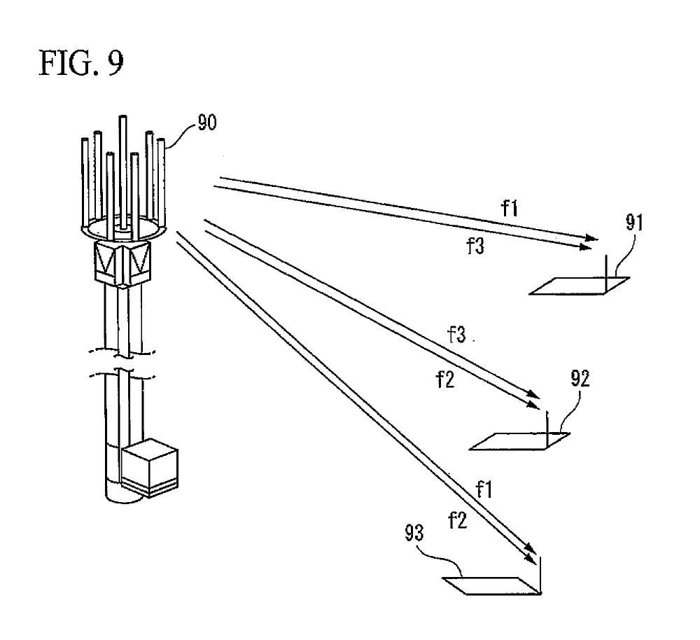

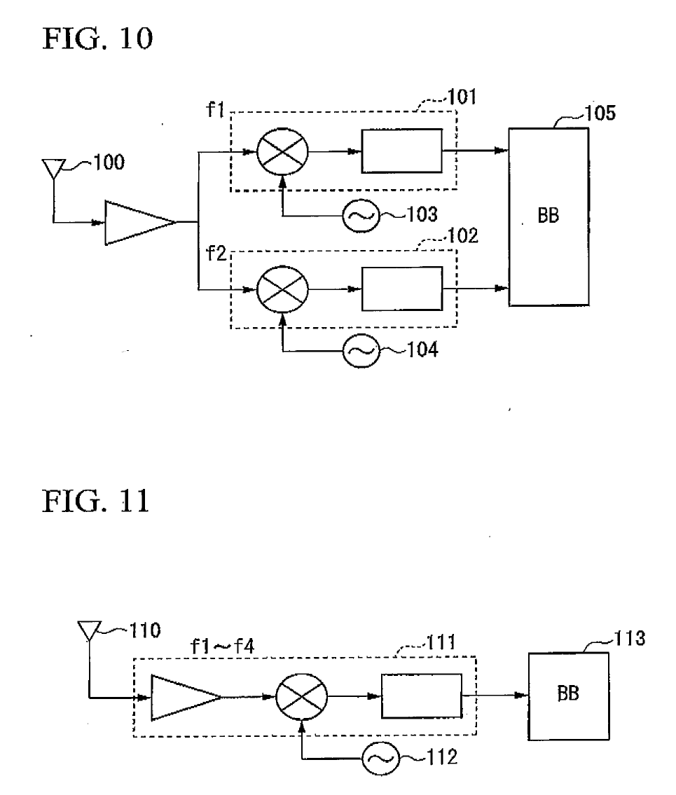

In the structure of each terminal in the present embodiment, (i) as shown in FIG. 10, a single antenna 100, a plurality of wireless communication parts 101 and 102, and a plurality of local transmitters 103 and 104 may be provided, or (ii) as shown in FIG. 11, a single wireless communication part 111 and a single local transmitter 112 may be provided while a BBS part 113 (as a wide-area receiver) performs frequency division. Therefore, a low-price terminal can be easily manufactured t while maintaining a preferable performance with respect to the entire system.

Embodiments of the present invention has been explained with reference to the drawings. However, concrete structures are not limited to the embodiments, and design modifications or the like can be made without departing from the scope of the present invention.

### INDUSTRIAL APPLICABILITY

The present invention is preferably applied to a wireless base station which communicates with terminals via communication channels divided by means of SDMA and FDMA.

1. A wireless base station for allocating one or more communication channels to each terminal so as to perform wireless communication therewith, the wireless base station comprises:
a communication state acquiring device for acquiring a communication state of each communication channel allocated to each terminal;
an interference channel determining device for selecting a communication channel having a worst communication state based on the communication state acquired by the communication state acquiring device, and determining one or more communication channels which interfere with the selected communication channel;
a terminal selecting device for selecting a terminal having a best communication state from among terminals to which each communication channel, which is determined by the interference channel determining device and interferes with the selected communication channel, is allocated; and
a communication channel allocating device for allocating a communication channel, which belongs to the one or more communication channels determined by the interference channel determining device and has been allocated to the terminal selected by the terminal selecting devices to a new terminal which is going to newly communicate with the wireless base station.

2. The wireless base station in accordance with claim 1, wherein:
when there is a communication channel which has not yet been allocated, the communication channel allocating device gives priority to this communication channel to be allocated to the new terminal.

3. The wireless base station in accordance with claim 1, wherein:
the communication channels to be allocated include communication channels obtained by combined channel division which use both a space division multiplexing method and a second division multiplexing method; and
as the communication channel to be allocated by the wireless base station to the new terminal, among the already-allocated communication channels, a communication channel obtained by the combined channel division is given priority in comparison with a communication channel obtained by channel division which uses only the space division multiplexing method.

4. The wireless base station in accordance with claim 3, wherein:
said second division multiplexing method is a frequency division multiplexing method.

5. The wireless base station in accordance With claim 1, wherein:
said communication channel having the worst communication state and said one or more communication channels which interfere with this communication channel are obtained by charnel division which uses only a space division multiplexing method.

6. The wireless base station in accordance with claim 1, wherein:
the communication state acquired by the communication state acquiring device is a throughput of each communication channel allocated to each terminal.

7. A channel allocating system including terminals and a wireless base station for allocating one or more communication channels to each of the terminals so as to perform wireless communication therewith, wherein:
the wireless base station comprises:
a communication state acquiring device for acquiring a communication state of each communication channel allocated to each terminal;
an interference channel determining device for selecting a communication channel having a worst communication state based on the communication state acquired by the communication state acquiring device, and determining one or more communication channels which Interfere with the selected communication channel;
a terminal selecting device for selecting a terminal having a best communication state from among terminals to which each communication channel, which is determined by the interference channel determining device and interferes with the selected communication channel, is allocated; and
a communication channel allocating device for allocating a communication channel, which belongs to the One or more communication channels determined by the interference channel determining device and hag been allocated to the terminal selected by the terminal selecting device, to a new terminal which is going to newly communicate with the wireless base station.

8. A channel allocating method used in a wireless base station for allocating one or more communication channels to each terminal so as to perform wireless communication therewith, the method comprising:
an acquisition step of acquiring each already-allocated communication channel;
a determination step of determining whether there is a communication channel which has been divided from said each already-allocated communication channel by a multiplexing method other than a space division multiplexing method, and has not yet been allocated; and
a control step of controlling the channel allocation in accordance with the determination in the determination step.

9. The channel allocating method in accordance with claim 9, wherein:
when it is determined in the determination step that there is a communication channel which has been divided by the multiplexing method other titan the space division multiplexing method and has not yet been allocated, then in the control step, said communication channel which has not yet been allocated is given priority in the channel allocation.

10. The channel allocating method in accordance with claim 8, wherein:
in the determination step, when it is determined that there is no communication channel which has been divided by the multiplexing method other than the space division multiplexing method and has not yet been allocated, then it is further determined whether there is a communication channel which has been divided by the space division multiplexing method and has not yet been allocated; and
when there is a communication channel which has been divided by the space division multiplexing method and has not yet been allocated, then in the control step, said communication channel which has not yet been allocated is given priority in the channel allocation.

11. The channel allocating method in accordance with claim 8, wherein:
in the determination step, when it is determined that there is no communication channel which has been divided by the multiplexing method other than the space division multiplexing method and has not yet been allocated, then it is further determined whether there is a communication channel which has been divided by the space division multiplexing method and has not yet been allocated; and
when in the control step, there is no communication channel which has been divided by the space division multiplexing method and has not yet been allocated, then the method further comprises:
a step of acquiring a communication state of each communication channel allocated to each terminal;
a step of selecting a communication channel having a worst communication state based on the acquired communication state, and determining one or more communication channels which interfere with the selected communication channel;
a step of selecting a terminal having a best communication state from among terminals to which each determined communication channel interfering with the selected communication channel is allocated; and
a step of allocating a communication channel, which belongs to the determined one or more communication channels and has been allocated to the selected terminal, to a new terminal which is going to newly communicate with the wireless base station.

12. The channel allocating method in accordance with claim 8, wherein:
said multiplexing method other than the space division multiplexing method is a frequency division multiplexing method.
